(19) United States
(12) Patent Application Publication
(10) Pub. No.: US 2005/0217948 A1
(43) Pub. Date: Oct. 6, 2005

(54) Cast brake disc

(76) Inventor: Peter Kerslake, LLISWERRY, NEWPORT (GB)

Correspondence Address: CARLSON, GASKEY & OLDS, P.C., 400 WEST MAPLE ROAD, SUITE 350, BIRMINGHAM, MI, 48009, US

(21) Appl. No.: 10/503,530

(22) PCT Filed: Feb. 4, 2003
(86) PCT No.: PCT/GB03/00468

§ 371 Date: Mar. 31, 2005

(30) Foreign Application Priority Data
Feb. 5, 2002 (GB) 0202620.1

(51) Int. Cl. F16D 55/00

(52) U.S. Cl. 188/71.1

(57) ABSTRACT

A cast brake disc includes a mounting flange connected to an annular disc (16) by a rotor bell. The rotor bell has an axially cast recess, and the annular disc includes cast ventilation vanes defining ventilation holes. The rotor bell includes one or more radially oriented cast holes suitable, during manufacture, for connecting a casting core portion that provides the axially cast recess to a casting core portion that provides the ventilation holes. The annular disc includes a first braking face, defining a first braking face plane proximate the mounting flange and a second braking face remote from the mounting flange. An edge of the radially oriented cast hole is substantially aligned with the first braking face plane, and the center of the radially oriented cast hole is positioned on the mounting flange side of the edge.

The present invention relates to a cast brake disc and a method of making a bare casting for a cast brake disc.

Cast brake discs comprising a mounting flange connected to an annular disc by a rotor bell are known. Typically the rotor bell will have an annular cast recess and the mounting flange will also have a central cast hole. The rotor bell recess and flange hole are provided by the use of a casting core.

Furthermore it is known to provide the annular disc with ventilation holes. Various ventilation patterns can be used and again typically these are provided by a further casting core.

Thus the known method of providing a cast ventilated brake disc is to provide a bottom (first) casting mould, position the rotor bell recess and flange hole core in the mould, position the (separate) disc ventilation hole core in the mould, close the mould with a top (second) casting mould and then pour the casting. Under such circumstances, the mould has a horizontal split line.

In particular because two separate cores are used, they have to be individually supported in the mould and the support arrangement takes up mould space. Furthermore, in order to evenly support both cores, the brake disc is cast horizontally, i.e. with the plane of the annular disc being horizontal.

This results in cores which take up a considerable amount of casting box space. Furthermore, because the first and second cores have to be positioned in the mould separately, then close tolerances cannot be achieved. Thus the casting has to be designed oversize such that subsequent machining can achieve correct tolerances. Clearly this results in a wastage of casting material and also excessive machining costs.

Thus according to the present invention there is provided a cast brake disc comprising a mounting flange connected to an annular disc by a rotor bell, the rotor bell having an axially cast recess, the annular disc including cast ventilation vanes defining ventilation holes, in which the rotor bell includes one or more radially orientated cast holes suitable, during manufacture, for connecting a casting core portion providing the axially cast recess to a casting core portion providing the ventilation holes in which the annular disc includes a first braking face, defining a first braking face plane, proximate the mounting flange and a second braking face remote from the mounting flange, in which an edge of the radially orientated cast hole is substantially in line with the first braking face plane with the centre of the radially orientated cast hole being positioned on the mounting flange side of said edge.

According to a further aspect of the present invention there is provided a cast brake disc comprising a mounting flange connected to an annular disc by a rotor bell, the rotor bell having an axially cast recess, the annular disc including cast ventilation vanes defining ventilation holes, in which the rotor bell includes one or more radially orientated cast holes suitable, during manufacture, for connecting a casting core portion providing the axially cast recess to a casting core portion providing the ventilation holes, in which the annular disc includes a first braking face, defining a first braking face plane, proximate the mounting flange and a second braking face remote from the mounting flange, in which no part of the radially orientated cast hole is positioned on the second braking face side of the first braking face plane.

According to a further aspect of the present invention there is provided a method of making a bare casting for a cast brake disc including the steps of
providing a first casting mould,
providing a second casting mould,
providing a single core having a rotor bell axial recess portion connected to an annular disc ventilation holes portion via one or more radially orientated connecting portions,
mounting the core in the first casting mould,
closing the mould with the second casting mould
pouring the casting
allowing the casting to cool
removing the bare casting from the mould,
such that the annular disc includes a first cast braking face, defining a first cast braking face plane, proximate the mounting flange and a second cast braking face remote from the mounting flange, in which an edge of the radially orientated cast hole is substantially in line with the first cast braking face plane with the centre of the radially orientated cast hole being positioned on the mounting flange side of said edge.

According to a further aspect of the present invention there is provided a method of making a bare casting for a cast brake disc including the steps of
providing a first casting mould,
providing a second casting mould,
providing a single core having a rotor bell axial recess portion connected to an annular disc ventilation holes portion via one or more radially orientated connecting portions, mounting the core in the first casting mould,
closing the mould with the second casting mould
pouring the casting
allowing the casting to cool
removing the bare casting from the mould,
such that the annular disc includes a fist cast braking face, defining a first cast braking plate plane, proximate the mounting flange and a second cast braking face remote from the mounting flange, in which no part of the radially orientated cast hole is provided on the second cast braking face side of the first cast braking face plane.

The invention will now be described, by way of example only, with reference to the accompanying drawings, in which:

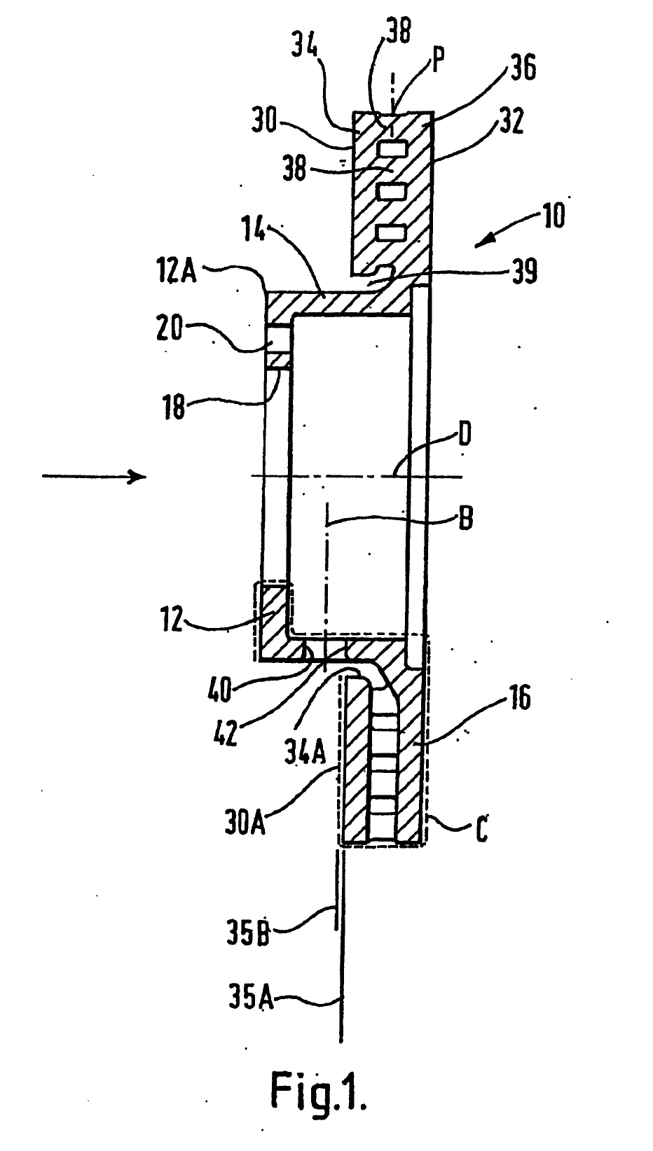

FIG. 1 is a cross section of a cast brake disc according to the present invention,

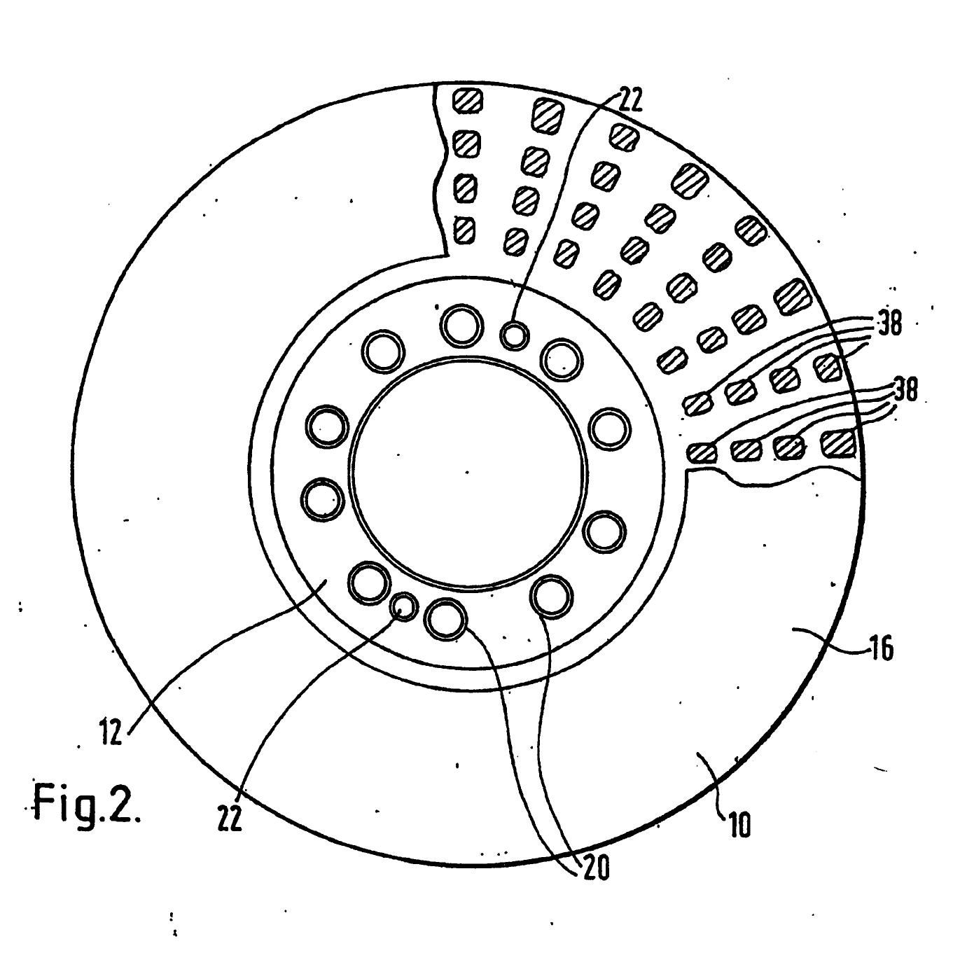

FIG. 2 is a view of the cast brake disc of FIG. 1 taken in the direction of row A,

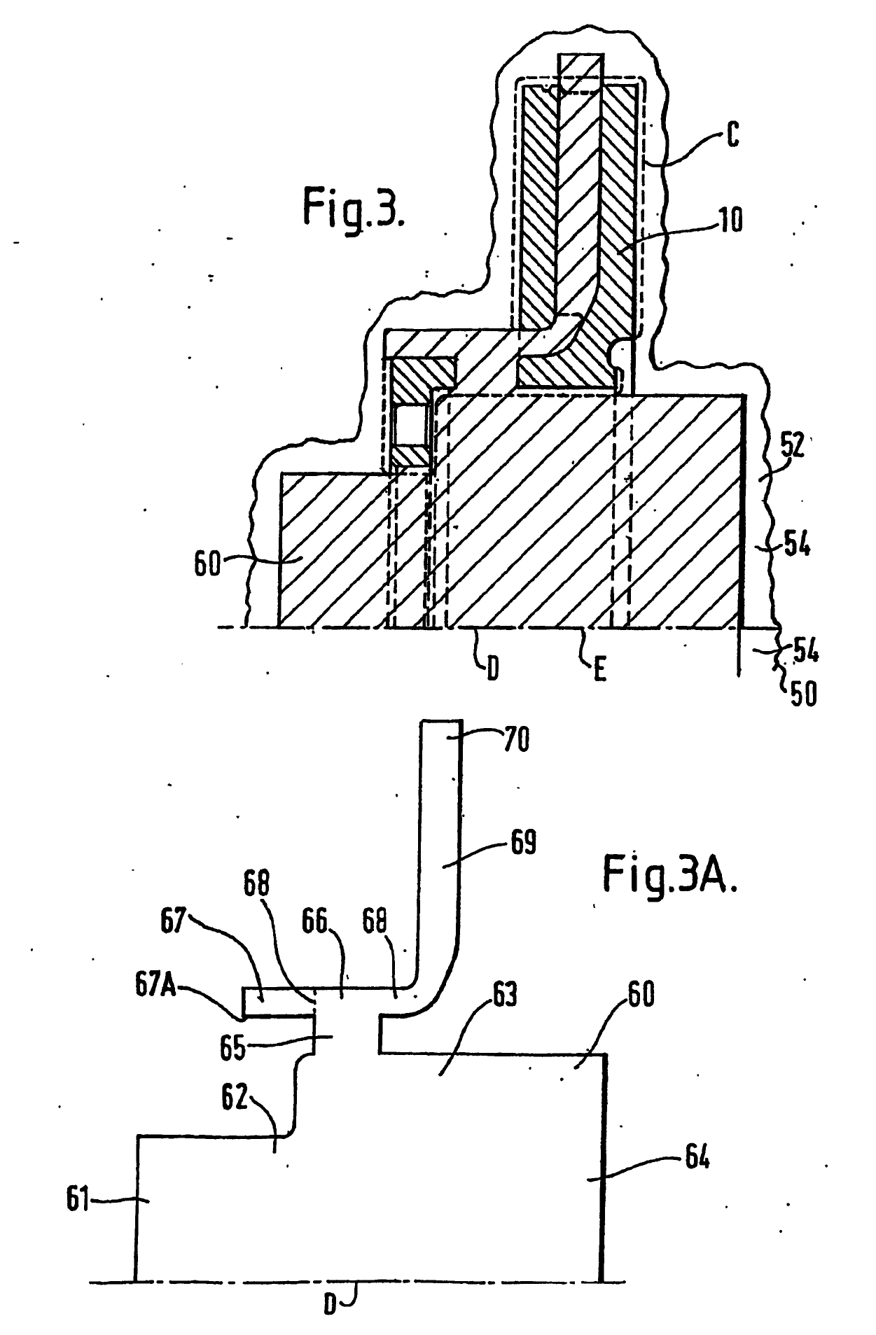

FIG. 3 is a cross section of the cast brake disc of FIG. 1 showing the casting core and mould,

FIG. 3A shows the casting core of FIG. 3 in isolation, and

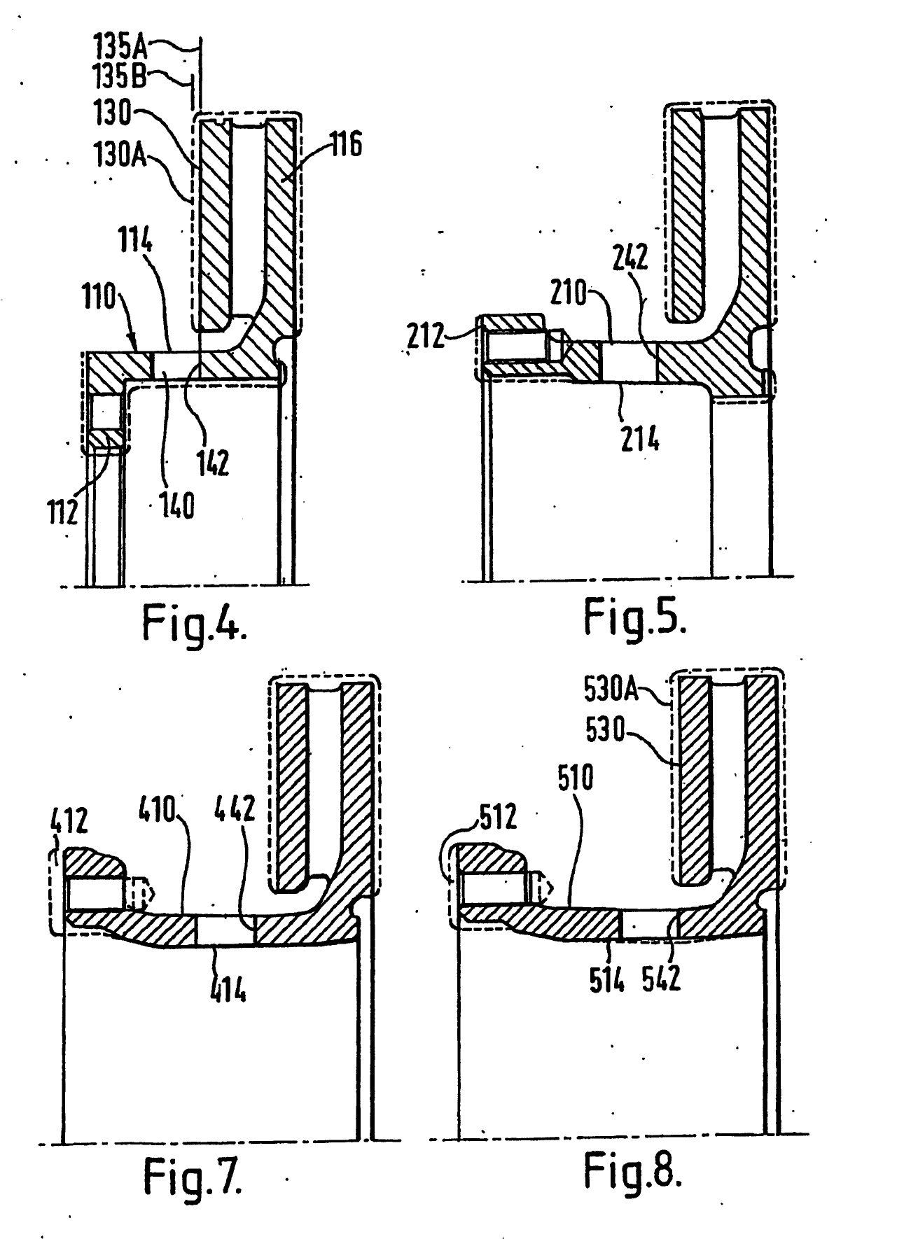

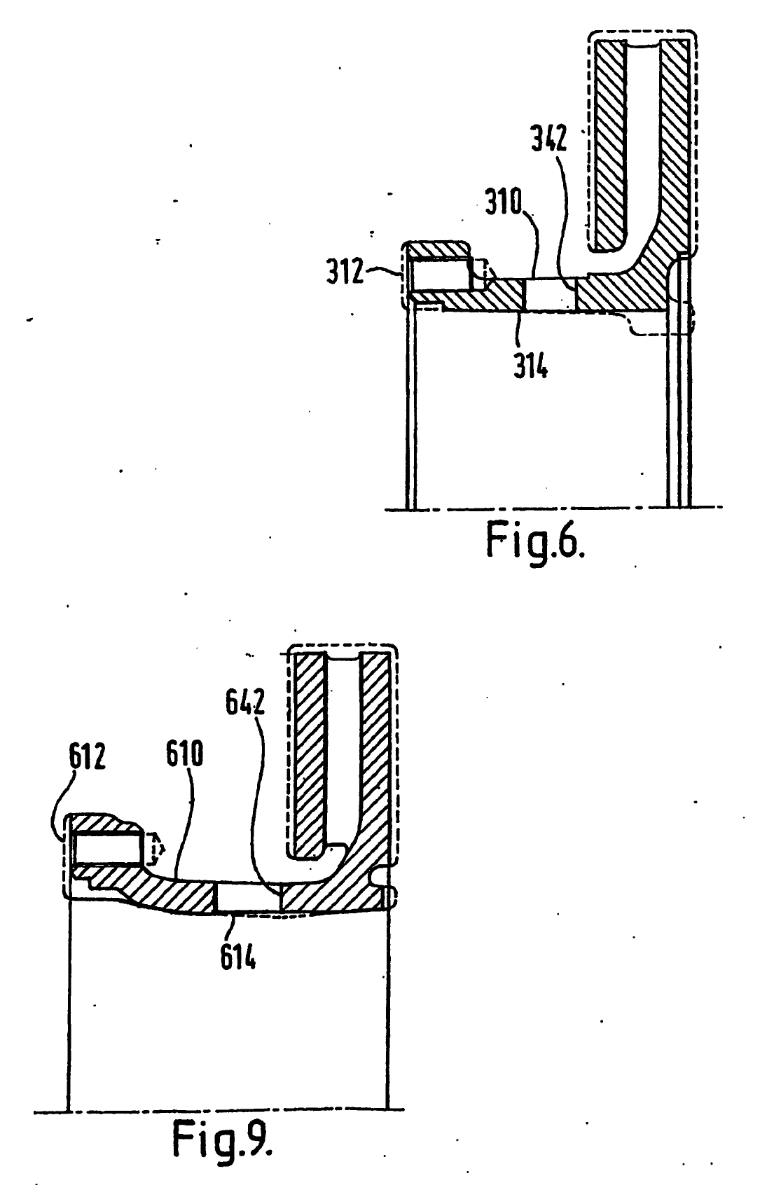

FIGS. 4 to 9 are further cross section views of cast brake discs according to the present invention.

With reference to FIGS. 1 to 3A there is shown a cast brake disc 10 having a mounting flange 12, a rotor bell 14 and an annular disc 16.

The mounting flange includes a cast central hole 18 and mounting holes 20. The flange further includes threaded demounting holes 22.

The annular disc 16 defines a plane P and includes a first (outboard) braking face 30, proximate the mounting flange 12 and a second (inboard) braking face 32.

The first braking face 30 is provided on an outboard cheek 34 and the second braking face is provided on an inboard cheek 36.

The first braking face 30 defines a first braking face plane 35A.

The outboard and inboard cheeks are connected via ventilation vanes 38. In this case four radially aligned discreet vanes are provided as a set, the set being repeated at circumferential intervals around the disc brake, as best seen in FIG. 2.

In further examples different vane patterns can be used.

In particular it should be noted that outboard cheek 34 has a continuous radially inner edge 34A, radially spaced from an adjacent portion of the rotor bell 14 which provides a continuous annular ventilation gap 39.

The rotor bell 14 is substantially cylindrical in shape and includes 3 radially orientated cast holes 40 (only one of which is shown). The holes are positioned circumferentially at 120° to each other. Each hole is circular and is nominally 25 mm in diameter. The axis of the hole is shown at B. It can be seen that an inner edge 42 of the hole 40 is substantially aligned with the first (outboard) braking face 30 with the axis B being positioned on the mounting flange (12) side of this edge 42.

Note that the chain dotted line C defines the bare casting profile of the disc prior to final machining. In particular, the first braking face 30 has a premachined surface 30A which defines a first cast braking plane 35B. In use, the disc rotates about axis D.

The bare casting for the cast brake disc 10 is made as follows.

FIG. 3 shows a first (bottom) casting mould 50 (only part shown) and a second (upper) casting mould 52.

The casting moulds typically comprises a casting box (not shown) partially filled with casting sand 54 into which the impression of a casting pattern has been impressed. The casting box split line is horizontal and is shown at E which, in this case, is coincident with the rotational axis D of the disc 10.

A single casting core 60 is positioned in the casting mould.

FIG. 3A best shows the casting core 60 which comprises support portions 61, 64 and 70 which engage the casting sand to support the casting core in the mould. Support portions 61, 64 and 70 are annular.

Portion 62 provides the cast mounting flange central hole, and is annular.

Portion 63 provides the rotor bell axial recess, and is annular.

Portion 68 provides the annular ventilation gap 39 and is annular.

Portion 69 provides the ventilation holes and its shape can best be understood by consideration of FIG. 2.

Portion 65 provides one of the three radially orientated cast holes 40. Two further portions similar to portion 65 are provided circumferentially spaced at 120° from portion 65 to provide the other two radially orientated cast holes.

Portion 66 is annular and circumferentially connects the three radially oriented cast hole portions 65. In particular by providing portion 66 the core can be placed in the mould in any rotational orientation when considering axis D, i.e. the rotational position of the radially orientated cast hole portions 65 within the mould can be random.

Portion 67 provides an annular projection connected to portion 66. The left hand end of portion 67 surrounds the mounting flange 12 and edge 67A of the core substantially aligns with edge 12A of the mounting flange. Thus, any casting flash is conveniently located on a corner of the finished casting and is therefore easily removable.

However, in an alternative embodiment portion 67 may be absent from the core which would then terminate at the dotted line 68 shown in FIG. 3A. Thus, by removal of portion 67, the mould for the core no longer has to accommodate a draft angle on portion 67.

It should be noted that since the split line E is horizontal, then the plane P of the annular disc is situated vertically within the mould. Thus when using standard moulding boxes, it is possible to cast three discs in one moulding box whereas previously when the discs were cast horizontally, only two discs per casting box were possible.

One of the significant costs of casting is the casting sand itself, and in particular the cleaning of the casting sand once used.

Use of the present invention firstly allows less casting sand to be used per casting box (since it is possible to cast three discs rather than two) and additionally less casting sand is required to be cleaned per disc cast.

By positioning edge 42 of the radially orientated cast holes substantially in line with the first (outboard) braking face 30, the offset of portions 68, 69 and 70 of the core can be minimised whilst maintaining the integrity of the finished disc brake since it has been found that when a substantial part of the cast hole 40 lies radially within cheek 34A this causes locally increased thermal stresses as a result of heating of the annular disc 16 in use resulting in premature failure of the disc.

The FIGS. 4 to 9 show further embodiments of a cast brake disc according to the present invention with features equivalent to cast brake disc 10 labelled 100, 200, 300, 400, 500 and 600 greater respectively.

It can be seen from FIG. 4 that edge 142 is substantially in line with plane 135A. Since plane 135A is defined by the finished machine surface of braking face 130, edge 142 is positioned to the right of first cast braking face 130A when viewing the figure. It can be seen from FIG. 8 that edge 542 is also substantially in line with the plane defined by first braking face 530.

FIGS. 5, 6, 7 and 9 show brake discs wherein the edges 242, 342, 442 and 642 are all positioned to the left of the associated first braking face, and also to the left of the associated first cast braking face. Such arrangements require a larger offset between those portions of the core that provide the cast holes (equivalent to portions 65 of FIG. 3A) and those portions of the core providing the ventilation holes (equivalent to portion 69 of FIG. 3A). Increasing the distance between these two regions of the core makes for a less stable core, but nevertheless can pay dividends in the finished article, in as much as locally induced thermal stresses beneath the outboard cheek, in use, can be reduced.

1. A cast brake disc comprising:
a rotor bell including an axially cast recess and at least one radially oriented cast hole having an edge and a central axis, wherein a first casting core portion provides the axially cast recess;
an annular disc including cast ventilation vanes defining ventilation holes, a first braking face defining a braking face plane, and a second braking face, wherein a second casting core portion provides the ventilation holes, and the at least one radially oriented cast hole connects the first casting core portion to the second casting core portion during manufacture; and
a mounting flange connected to the annular disc by the rotor bell, wherein the first braking face of the annular disc is proximate to the mounting flange and the second braking face of the annular disc is remote from the mounting flange, wherein the edge of the at least one radially oriented cast hole is substantially aligned with the braking face plane and the central axis of the at least one radially oriented cast hole is located between the edge of the at least one radially oriented cast hole and the mounting flange.

2. A cast brake disc comprising:
a rotor bell including an axially cast recess and at least one radially oriented cast hole, wherein a first casting core portion provides the axially cast recess;
an annular disc including cast ventilation vanes defining ventilation holes, a first braking face defining a braking face plane, and a second braking face, wherein a second casting core portion provides the ventilation holes, and the at least one radially oriented cast hole connects the first casting core portion to the second casting core portion during manufacture; and
a mounting flange connected to the annular disc by the rotor bell, wherein the first braking face of the annular disc is proximate to the mounting flange and the second braking face of the annular disc is remote from the mounting flange, and wherein the entire at least one radially oriented cast hole is positioned on side of the braking face plane proximate to the mounting flange.

3. The cast brake disc as defined in claim 1 wherein the at least one radially oriented cast hole is substantially circular.

4. The cast brake disc as defined in claim 1 wherein the at least one radially oriented cast hole comprises three radially oriented cast holes.

5. The cast brake disc as defined in claim 1 wherein the first braking face is separated from the rotor bell by a continuous annular ventilation gap.

6. A method of making a bare casting for a cast brake disc comprising the steps of:
providing a single core including a rotor bell axial recess portion connected to an annular disc ventilation holes portion via at least one radially oriented connecting portion;
mounting the single core in a first casting mold;
closing the first casting mold with a second casting mold;
pouring a casting;
cooling the casting to form a bare casting; and
removing the bare casting from the first casting mold and the second casting mold, the bare casting including a mounting flange, an annular disc, and a rotor bell, the rotor bell including at least one radially oriented cast hole having an edge and a central axis, wherein the annular disc includes a first cast braking face defining a cast braking face plane proximate to the mounting flange and a second cast braking face remote from the mounting flange, wherein the edge of the at least one radially oriented cast hole is substantially aligned with the cast braking face plane and the central axis of the at least one radially oriented cast hole is located between the edge of the at least one radially oriented cast hole and the mounting flange.

7. The method as defined in claim 6 wherein the entire at least one radially oriented cast hole is provided on a side of the cast braking face plane proximate to the mounting flange.

8. The method as defined in claim 6 wherein the annular disc ventilation holes portion of the single core defines a portion plane, wherein the single core is mounted in the first casting mold such that the portion plane is substantially vertical.

9. The method as defined in claim 8 wherein the first casting mold and the second casting mold include a horizontal split line.

10. The method as defined in claim 6 wherein the annular disc ventilation holes portion of the single core includes a continuous annular ventilation gap portion at a radially innermost edge of the annular disc ventilation holes portion.

11. The method as defined in claim 6 wherein the single core includes a continuous annular portion surrounding the at least one radially oriented connecting portion.

12. The method as defined in claim 11 wherein the single core includes an annular projection connected to the continuous annular portion, and the annular projection faces away from the first cast braking face.

13. The method as defined in claim 12 wherein the annular projection surrounds the mounting flange of the bare casting.

14. The cast brake disc as defined in claim 2 wherein the at least one radially oriented cast hole is substantially circular.

15. The cast brake disc as defined in claim 2 wherein the at least one radially oriented cast hole comprises three radially oriented cast holes.

16. The cast brake disc as defined in claim 2 wherein the first braking face is separated from the rotor bell by a continuous annular ventilation gap.
